(19) United States
(12) Patent Application Publication
(10) Pub. No.: US 2009/0286061 A1
(43) Pub. Date: Nov. 19, 2009

(54) TRANSPARENT POLYMER FILM AND METHOD FOR PRODUCING IT, OPTICAL COMPENSATORY FILM, LAMINATE FILM AND LIQUID CRYSTAL DISPLAY DEVICE

(75) Inventor: Yasuyuki Sasada, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 12/095,178

(22) PCT Filed: Nov. 30, 2006
(86) PCT No.: PCT/JP2006/324393

§ 371 Date: May 28, 2008

(30) Foreign Application Priority Data
Nov. 30, 2005 (JP) 2005-346290

(51) Int. Cl. B32B 23/00; B29C 55/06; C08J 5/18; C08B 3/00; C08B 3/06

(52) U.S. Cl. 428/220; 264/288.4; 264/175; 428/304.4; 536/58; 536/69; 428/532; 428/508

(57) ABSTRACT

A method for producing a transparent polymer film, which comprises stretching a starting transparent polymer film by at least 10% at (Tg+50)° C. or higher wherein the starting transparent polymer film has a water vapor permeability at 40° C. and 90% RH of at least 100 g/(m²·day) in terms of the film having a thickness of 80 μm. The method provides a transparent polymer film having a high modulus of elasticity, a suitable water vapor permeability and little dimensional change.

### TECHNICAL FIELD

The present invention relates to a transparent polymer film having a high modulus of elasticity and a suitable water vapor permeability and having little dimensional change, and a method for producing it. The invention also relates to an optical compensatory film, a laminate film, a polarizer and a liquid crystal display device comprising the transparent polymer film.

### BACKGROUND ART

A polymer film of typically cellulose ester, polyester, polycarbonate, cycloolefin polymer, vinyl polymer, polyimide and the like is used in silver halide photographic materials, optical compensatory films, polarizers and image display devices. From these polymers, films having more excellent surface smoothness and uniformity can be produced, and therefore the films are widely employed for optical applications.

Of those, a cellulose ester film having a suitable water vapor permeability can be directly stuck to a most popular polarizing film of polyvinyl alcohol (PVA)/iodine, in on-line operation. Accordingly, cellulose acylate, especially cellulose acetate and cellulose acetate propionate are widely employed for a protective film for polarizers.

In a liquid crystal display device comprising a polarizer of that type, the polarizer has a highly-stretched polarizing film, and therefore, with the dimensional change of the polarizer therein owing to the external environmental change, light leakage may occur at four edges or four corners of the display panel of the liquid crystal display device. The light leakage is readily visible and may have a significant influence on the quality of the display device, and therefore it is a serious problem to be solved.

As a measure to it, disclosed is a method of making an adhesive for sticking a polarizer to any other member have a function of stress absorption and relaxation to thereby reduce the optical defects (for example, see JP-A-2000-109771). The method may be effective for reducing the defects, but is ineffective for preventing the dimensional change of polarizer that is the essential reason for the defects, and therefore it is desired to improve the method in this respect.

### DISCLOSURE OF THE INVENTION

An object of the invention is to provide a transparent polymer film having a high modulus of elasticity and a suitable water vapor permeability and having little dimensional change, and to provide a method for producing it. Another object of the invention is to provide an optical compensatory film comprising the transparent polymer film of the invention, and to provide a laminate film and a polarizer capable of exhibiting excellent optical properties that are obtained by directly sticking the transparent polymer film of the invention to any other polymer film as an optical compensatory film, as a support of an optical compensatory film or as a laminate film. Still another object of the invention is to provide a liquid crystal display device of high reliability, which is free from a trouble of light leakage that may occur in the peripheral area of the screen panel thereof owing to the environmental heat or moisture change.

The above objects can be attained by the following means.

### Embodiment 1

A method for producing a transparent polymer film, which comprises stretching a starting transparent polymer film by at least 10% at (Tg+50)° C. or higher wherein the starting transparent polymer film has a water vapor permeability at 40° C. and 90% RH of at least 100 g/(m²·day) in terms of the film having a thickness of 80 μm, and Tg is a glass transition temperature of the starting transparent polymer film.

### Embodiment 2

The method for producing a transparent polymer film of embodiment 1, wherein the stretching is effected at (Tg+60)° C. or higher.

### Embodiment 3

The method for producing a transparent polymer film of embodiment 1 or 2, wherein the stretching is effected at 200° C. or higher.

### Embodiment 4

The method for producing a transparent polymer film of any one of embodiments 1 to 3, wherein the modulus of elasticity of the transparent polymer film increases, after stretched, by from 1.1 to 100 times that of the unstretched film.

### Embodiment 5

The method for producing a transparent polymer film of any one of embodiments 1 to 4, wherein the stretching is effected at a stretching rate of at least 20%/min.

### Embodiment 6

The method for producing a transparent polymer film of any one of embodiments 1 to 5, wherein the stretching is machine-direction stretching to be effected in a device that has a heating zone between at least two nip rolls having a different peripheral speed.

### Embodiment 7

A transparent polymer film produced according to the production method of any one of embodiments 1 to 6.

### Embodiment 8

A transparent polymer film having a modulus of elasticity of at least 5 GPa and having a water vapor permeability at 40° C. and 90% RH of from 100 to 2000 g/(m²·day) in terms of the film having a thickness of 80 μm.

### Embodiment 9

The transparent polymer film of embodiment 7 or 8, which has a humidity-dependent expansion coefficient of at most 6×10⁻⁵% RH.

### Embodiment 10

The transparent polymer film of any one of embodiments 7 to 9, which has a whole light transmittance of at least 90%.

### Embodiment 11

The transparent polymer film of any one of embodiments 7 to 10, which has a haze of at most 2%.

### Embodiment 12

The transparent polymer film of any one of embodiments 7 to 11, which contains a cellulose ester as the essential polymer ingredient thereof.

### Embodiment 13

The transparent polymer film of embodiment 12, wherein the cellulose ester is a cellulose acetate.

### Embodiment 14

An optical compensatory film having at least one transparent polymer film of any one of embodiments 7 to 13.

### Embodiment 15

An optical compensatory film having an optically anisotropic layer on a transparent polymer film of any one of embodiments 7 to 13.

### Embodiment 16

The optical compensatory film of embodiment 15, wherein the optically anisotropic layer contains a discotic liquid crystal.

### Embodiment 17

The optical compensatory film of embodiment 15, wherein the optically anisotropic layer contains a rod-shaped liquid crystal.

### Embodiment 18

The optical compensatory film of any one of embodiments 15 to 17, wherein the optically anisotropic layer is a polymer film.

### Embodiment 19

The optical compensatory film of embodiment 18, wherein the polymer film contains at least one polymer material selected from a group consisting of polyamide, polyimide, polyester, polyether ketone, polyamidimide, polyesterimide and polyarylether ketone.

### Embodiment 20

A laminate film having at least one transparent polymer film of any one of embodiments 7 to 13.

### Embodiment 21

A laminate film comprising at least one transparent polymer film of any one of embodiments 7 to 13, and any other polymer film stuck thereto.

### Embodiment 22

The laminate film of embodiment 21, wherein the angle between the direction in which the modulus of elasticity of the transparent polymer film is the largest and the direction in which the modulus of elasticity of the other transparent polymer film is the largest is at most 15°.

### Embodiment 23

The laminate film of embodiment 21 or 22, wherein the essential polymer ingredient of the other transparent polymer film is a polyvinyl alcohol.

### Embodiment 24

The laminate film of any one of embodiments 21 to 23,

wherein the other transparent polymer film is apolarizing film.

### Embodiment 25

The laminate film of any one of embodiments 20 to 24, which has a whole light transmittance of at most 50%.

### Embodiment 26

A polarizer having at least one transparent polymer film of any one of embodiments 7 to 13.

### Embodiment 27

A polarizer comprising a laminate film of any one of embodiments 20 to 25.

### Embodiment 28

The polarizer of embodiment 26 or 27, which has, formed on its surface, at least one layer selected from a hard coat layer, an antiglare layer and an antireflection layer.

### Embodiment 29

A liquid crystal display device having at least one film selected from a group consisting of a transparent polymer film of any one of embodiments 7 to 13, an optical compensatory film of any one of embodiments 14 to 19, a laminate film of any one of embodiments 20 to 25, and a polarizer of any one of embodiments 26 to 28.

The invention provides a transparent polymer film having a high modulus of elasticity and a suitable water vapor permeability and having little dimensional change, and a method for producing it. The invention also provides an optical compensatory film comprising the transparent polymer film of the invention, and provides a laminate film and a polarizer capable of exhibiting excellent optical properties that are obtained by directly sticking the transparent polymer film of the invention to any other polymer film as an optical compensatory film, as a support of an optical compensatory film or as a laminate film, in on-line operation. The invention also provides a liquid crystal display device of high reliability, which is free from a trouble of light leakage that may occur in the peripheral area of the screen panel thereof owing to the environmental heat or moisture change.

### BEST MODE FOR CARRYING OUT THE INVENTION

The transparent polymer film and a method for producing it, and a retardation film, a laminate film, a polarizer and a liquid crystal display device of the invention are described in detail hereinunder. The description of the constitutive elements of the invention given hereinunder may be for some typical embodiments of the invention, to which, however, the invention should not be limited. In this description, the numerical range expressed by the wording “a number to another number” means the range that falls between the former number indicating the lowermost limit of the range and the latter number indicating the uppermost limit thereof.

### <<Transparent Polymer Film>>

The transparent polymer film of the invention has a modulus of elasticity of at least 5 GPa and has a water vapor permeability at 40° C. and 90% RHof from 100 to 2000 g/(m²·day) in terms of the film having a thickness of 80 μm.

### [Modulus of Elasticity]

In the invention, the modulus of elasticity is determined as follows: A film sample having a length of 150 mm and a width of 10 mm is prepared, this is conditioned at 25° C. and 60% RH for 24 hours, and then, according to the standard of ISO1184-1983, it is tested at an initial sample length of 100 mm and at a pulling rate of 10 mm/min. From the initial inclination of the stress-strain curve of the sample, the tensile modulus of elasticity is obtained. Depending on the length direction and the width direction of the sample cut out of a film, the modulus of elasticity of the film sample generally varies. In the invention, the film sample is prepared in the direction in which the modulus of elasticity of the sample is the largest, and the found value of the sample is the modulus of elasticity of the film directly as it is.

The modulus of elasticity of the film of the invention is at least 5 GPa, preferably from 6 to 30 GPa, more preferably from 7 to 20 GPa, even more preferably from 8 to 15 GPa. The method for controlling the modulus of elasticity to fall within the range as defined herein is described hereinunder.

### [Elastic Modulus Change]

In the invention, the elastic modulus change may be calculated according to the following formula:

Elastic Modulus Change [times]=E₁/E₀,

wherein E₀ indicates the modulus of elasticity of an unstretched film, obtained according to the above-mentioned method, and E₁ indicates the modulus of elasticity of the film after stretched.

In the invention, the elastic modulus change is preferably from 1.1 to 100 times, more preferably from 1.3 to 10 times, even more preferably from 1.5 to 8 times, still more preferably from 2 to 5 times. When the elastic modulus change is at least 1.1 times, then the polymer chain alignment may be promoted and therefore it is favorable in point of the possibility of reducing the dimensional change of the film having received external force applied thereto; and when the elastic modulus change is at most 100 times, it is also favorable because, when the film is used as a protective film of a polarizer, then the dimensional change of the polarizing element may be efficiently inhibited.

### [Humidity-Dependent Expansion Coefficient]

In the invention, the humidity-dependent expansion coefficient is determined as follows: A film sample having a length of 25 cm (in the machine direction) and a width of 5 cm is cut out of a film in such a manner that the direction in which the modulus of elasticity of the sample is the largest is the machine direction of the sample, and the film sample is pin-holed with at regular intervals of 20 cm. This is conditioned at 25° C. and 10% RH for 24 hours, and the distance between the adjacent pinholes is measured with a pin gauge (the found value is L₀). Next, the sample is conditioned at 25° C. and 80% RH for 24 hours, and then the distance between the adjacent pinholes is measured (the found value is L₁). From these values, the humidity-dependent expansion coefficient is calculated according to the following formula:

Humidity-Dependent Expansion Coefficient [/% RH]={(L₁−L₀)/L₀}/(R₁−R₀).

Preferably, the humidity-dependent expansion coefficient of the film of the invention is at most 6.0×10⁻⁵% RH, more preferably at most 4.0×10⁻⁵% RH, even more preferably at most 3.0×10⁻⁵% RH, most preferably at most 2.0×10⁻⁵% RH. When the humidity-dependent expansion coefficient is at most 6.0×10⁻⁵% RH, then it is favorable because, when the film is used as a protective film of a polarizer, then the polarizer is free from troubles of polarization degree depression or polarizing face displacement that may occur at around the peripheral area thereof before and after the polarizer is kept in a wet heat environment.

### [Whole Light Transmittance]

In the invention, the whole light transmittance is determined as follows: A sample having a length of 40 mm and a width of 80 mm is conditioned at 25° C. and 60% RH for 24 hours, and then tested at 25° C. and 60% RH according to the standard of JIS K-6714, using a haze meter (HGM-2DP, by Suga Test Instruments).

The whole light transmittance of the film of the invention is preferably at least 90%, more preferably at least 91%, even more preferably at least 92%, still more preferably at least 93%, especially preferably at least 94%.

### [Haze]

In the invention, the haze is determined as follows: A sample having a length of 40 mm and a width of 80 mm is conditioned at 25° C. and 60% RH for 24 hours, and then tested at 25° C. and 60% RH according to the standard of JIS K-6714, using a haze meter (HGM-2DP, by Suga Test Instruments).

The haze of the transparent polymer film of the invention is preferably at most 2%, more preferably at most 1%, even more preferably at most 0.5%, still more preferably at most 0.3%, and as the case may be, most preferably at most 0.2%.

### [Water Vapor Permeability]

In the invention, the water vapor permeability is determined as follows: A cup with calcium chloride put therein is covered with the film to be tested and airtightly sealed up therewith, and this is left at 40° C. and 90% RH for 24 hours. From the mass change (g/(m²·day)) before and after the conditioning, the water vapor permeability of the film is determined. The water vapor permeability increases with the ambient temperature elevation and with the ambient humidity increase, but not depending on the condition, the relationship of the water vapor permeability between different films does not change. Accordingly, in the invention, the water vapor permeability is based on the mass change at 40° C. and 90% RH. In addition, the water vapor permeability lowers with the increase in the film thickness and increases with the reduction in the film thickness. Accordingly, the found water vapor permeability value is multiplied by the found film thickness value, and then divided by 80, and the resulting value is the “water vapor permeability in terms of the film having a thickness of 80 μm” in the invention.

The water vapor permeability of the film of the invention is at least 100 g/(m²·day) in terms of the film having a thickness of 80 μm. When the film, of which the water vapor permeability is at least 100 g/(m²·day) in terms of the film having a thickness of 80 μm, is used, then it may be directly stuck to a polarizing film. The water vapor permeability in terms of the film having a thickness of 80 μm is preferably from 100 to 1500 g/(m²·day), more preferably from 300 to 1000 g/(m²·day).

When the transparent polymer film of the invention is used as an outer protective film, which is not disposed between a polarizing film and a liquid crystal cell, as will be described hereinunder, then the water vapor permeability of the transparent polymer film of the invention is preferably less than 500 g/(m²·day) in terms of the film having a thickness of 80 μm, more preferably from 100 to 450 g/(m²·day), even more preferably from 100 to 400 g/(m²·day), most preferably from 150 to 300 g/(m²·day). As defined to that effect, the durability of the polarizer resistant to moisture or wet heat may increase, and a liquid crystal display device of high reliability can be provided.

For preparing the film of the invention having a water vapor permeability of at least 100 g/(m²·day) in terms of the film having a thickness of 80 μm, it is desirable that the polymer hydrophilicity/hydrophobicity is suitably controlled, or the film density is lowered. For the former method, for example, the hydrophilicity/hydrophobicity of the polymer backbone chain may be suitably controlled, and hydrophobic or hydrophilic side chains may be introduced into the polymer. For the latter method, for example, side chains may be introduced into the polymer backbone chain, or the type of the solvent to be used in film formation is specifically selected, or the drying speed in film formation may be controlled.

### [Tg]

In the invention, the glass transition temperature (Tg) is determined as follows: 20 mg of the sample to be analyzed is put into a sample pan for DSC, heated in a nitrogen atmosphere at a rate of 10° C./min from 30° C. up to 250° C., and then cooled to 30° C. at a rate of −20° C./min. Then, this is again heated from 30° C. up to 250° C., and the temperature at which the base line of the temperature profile of the sample begins to deviate from the low-temperature side is referred to as the glass transition temperature (Tg) of the sample.

Tg of the film of the invention is preferably from 80° C. to 300° C., more preferably from 100° C. to 200° C., even more preferably from 1300° C. to 180° C.

### [Polymer]

The polymer to be the constitutive element of the transparent polymer film of the invention includes cellulose ester, polyester, polycarbonate, cycloolefin polymer, vinyl polymer, polyamide and polyimide. The polymer preferably has a hydrophilic structure such as a hydroxyl group, an amide group, an imido group or an ester group in the backbone chain or in the side chains thereof, for the purpose of attaining a suitable degree of water vapor permeability. The polymer is preferably cellulose ester.

The polymer may be powdery or granular, or may also be in the form of pellets.

Preferably, the water content of the polymer is at most 1.0% by mass, more preferably at most 0.7% by mass, most preferably at most 0.5% by mass. As the case may be the water content is preferably at most 0.2% by mass. In case where the water content of the polymer oversteps the preferred range, then it is desirable to use the polymer after dried by heating.

One or more these polymers may be used herein either singly or as combined.

The cellulose ester includes cellulose ester compounds, and ester-substituted cellulose skeleton-having compounds that are produced by biologically or chemically introducing a functional group to a starting cellulose material. Of those, especially preferred is cellulose acylate.

The essential polymer ingredient of the transparent polymer film of the invention is preferably the above-mentioned cellulose acylate. The “essential polymer ingredient” as referred to herein is, when the film is formed of a single polymer, that single polymer; but when the film is formed of plural polymers, then the polymer having a highest mass fraction of those constitutive polymers is the “essential polymer ingredient”.

The cellulose ester is an ester of cellulose and acid. The acid that constitutes the ester is preferably an organic acid, more preferably a carboxylic acid, even more preferably a fatty acid having from 2 to 22 carbon atoms, most preferably a lower fatty acid having from 2 to 4 carbon atoms.

The cellulose acylate is an ester of cellulose and carboxylic acid. In the cellulose acylate, all or a part of the hydrogen atoms of the hydroxyl groups existing at the 2-, 3- and 6-positions of the glucose unit that constitutes cellulose are substituted with an acyl group. Examples of the acyl group are an acetyl group, a propionyl group, a butyryl group, an isobutyryl group, a pivaloyl group, a heptanoyl group, a hexanoyl group, an octanoyl group, a decanoyl group, a dodecanoyl group, a tridecanoyl group, a tetradecanoyl group, a hexadecanoyl group, an octadecanoyl group, a cyclohexanecarbonyl group, an oleoyl group, a benzoyl group, a naphthylcarbonyl group, a cinnamoyl group. The acyl group is preferably an acetyl group, a propionyl group, a butyryl group, a dodecanoyl group, an octadecanoyl group, a pivaloyl group, an oleoyl group, a benzoyl group, a naphthylcarbonyl group, a cinnamoyl group, most preferably an acetyl group, a propionyl group, a butyryl group.

The cellulose ester may be an ester of cellulose with plural acids. The cellulose acylate may be substituted with plural acyl groups.

For the transparent polymer film of the invention, especially preferred is a cellulose acylate having an ester with acetic acid, or that is, cellulose acetate. From the viewpoint of its solubility in solvent, more preferred is cellulose acetate having a degree of acetyl substitution of from 2.70 to 2.87, and most preferred is cellulose acetate having a degree of acetyl substitution of from 2.80 to 2.86. The degree of acetyl substitution as referred to herein means an overall degree of substitution of the hydrogen atom of the hydroxyl group existing in the 2-, 3- and 6-positions of cellulose, with an acyl group; and when all the hydroxyl groups are substituted, then the degree of substitution is 3.

The basic principle of a method of production of cellulose acylate is described in Nobuhiko Migita, et al., Wood Chemistry, pp. 180-190 (Kyoritsu Publishing, 1968). One typical production method is a liquid-phase acetylation method with a carboxylic acid anhydride-carboxylic acid-sulfuric acid catalyst. Concretely, a cellulose material such as cotton linter or wood pulp is pretreated with a suitable amount of a carboxylic acid such as acetic acid, then esterified by putting it into a previously-cooled acylation mixture liquid to thereby produce a complete cellulose acylate (the total of the degree of acylation at the 2-, 3- and 6-position thereof is almost 3.00). The acylation mixture liquid generally contains a carboxylic acid serving as a solvent, a carboxylic acid anhydride serving as an esterifying agent and sulfuric acid serving as a catalyst. In general, the amount of the carboxylic acid anhydride is a stoichiometrically excessive amount over the total amount of the cellulose to be reacted with it and water existing in the system.

After the acylation, the excessive carboxylic acid anhydride still remaining in the system is hydrolyzed, for which water or water-containing acetic acid is added thereto. Then, a part of the esterification catalyst is neutralized, for which an aqueous solution of a neutralizing agent (e.g., calcium, magnesium, iron, aluminium or zinc carbonate, acetate, hydroxide or oxide) may be added to the system. Next, the obtained complete cellulose acylate is kept at 20 to 90° C. in the presence of a small amount of an acylation catalyst (generally, this is the remaining sulfuric acid) to thereby saponify and ripen it into a cellulose acylate having a desired degree of acyl substitution and a desired degree of polymerization. When the desired cellulose acylate is obtained, the catalyst still remaining in the system is completely neutralized with the above-mentioned neutralizing agent, or not neutralized, the cellulose acylate solution is put into water or diluted sulfuric acid (or water or diluted sulfuric acid is put into the cellulose acylate solution) to thereby separate the cellulose acylate, which is then washed and stabilized to be the intended cellulose acylate.

The degree of polymerization of the cellulose acylate is preferably from 150 to 500 in terms of the viscosity-average degree of polymerization thereof, more preferably from 200 to 400, even more preferably from 220 to 350. The viscosity-average degree of polymerization may be measured according to an Uda et al's limiting viscosity method (Kazuo Uda, Hideo Saito; the Journal of the Society of Fiber Science and Technology of Japan, Vol. 18, No. 1, pp. 105-120, 1962). The method for measuring the viscosity-average degree of polymerization is described also in JP-A-9-95538.

Cellulose acylate having a small amount of a low-molecular component may have a high mean molecular weight (degree of polymerization), but its viscosity is generally lower than ordinary cellulose acylate. Cellulose acylate having a small amount of a low-molecular component may be obtained by removing the low-molecular component from cellulose acylate produced in an ordinary manner. The removal of the low-molecular component may be attained by washing cellulose acylate with a suitable organic solvent. Further, cellulose acylate having a small amount of a low-molecular component may also be obtained by synthesis. When cellulose acylate having a small amount of a low-molecular component therein is produced, it is desirable that the amount of the sulfuric acid catalyst for use in acylation is controlled to be from 0.5 to 25 parts by mass relative to 100 parts by mass of cellulose. When the amount of the sulfuric acid catalyst is within the above range, then cellulose acylate may be produced which is favorable in point of the molecular weight distribution thereof (having a uniform molecular weight distribution).

The starting cellulose for cellulose ester and the method for producing it are described also in Hatsumei Kyokai Disclosure Bulletin (No. 2001-1745, published by the Hatsumei Kyokai on Mar. 15, 2001), pp. 7-12.

### <<Method for Producing Transparent Polymer Film>>

The transparent polymer film of the invention may be produced from a polymer solution that contains a polymer and various additives, according to a solution-casting film formation method. In case where the melting point of the polymer used, or the melting point of the mixture of the polymer and various additives is lower than the decomposition point thereof and higher than the stretching temperature mentioned below, then the transparent polymer film of the invention may also be formed according to a melt film formation method. The melt film formation method is described, for example, in JP-A-2000-352620.

Some preferred embodiments of the invention are described below for concretely disclosing the method for producing the transparent polymer film.

### [Polymer Solution]

### (Solvent)

The transparent polymer film of the invention may be produced, for example, from a polymer solution containing a polymer and optionally various additives, according to a solution-casting film formation method.

The essential solvent for the polymer solution (preferably a cellulose ester solution) for use in the production of the transparent polymer film of the invention is preferably an organic solvent that is a good solvent for the polymer. The organic solvent of the type is preferably an organic solvent having a boiling point of not higher than 80° C. from the viewpoint of reducing the drying load. More preferably, the boiling point of the organic solvent is from 10 to 80° C., even more preferably from 20 to 60° C. As the case may be, an organic solvent having a boiling point of from 30 to 45° C. may also be favorably used for the essential solvent.

The essential solvent includes halogenohydrocarbons, esters, ketones, ethers, alcohols and hydrocarbons. These may have a branched structure or a cyclic structure. The essential solvent may have two or more functional groups of ester, ketone, ether and alcohol (i.e., —O—, —CO—, —COO—, —OH). The hydrogen atom in the hydrocarbon moiety of the above ester, ketone, ether and alcohol may be substituted with a halogen atom (especially, fluorine atom). The essential solvent of the polymer solution (preferably cellulose ester solution) for use in the production of the transparent polymer film of the invention is, when a single solvent is used in the polymer solution, that single solvent; but when plural solvents are used in the polymer solution, then the solvent having a highest mass fraction of those constitutive solvents is the essential solvent.

The halogenohydrocarbon is preferably a chlorohydrocarbon, for example, including dichloromethane and chloroform. More preferred is dichloromethane.

The ester includes, for example, methyl formate, ethyl formate, methyl acetate, ethyl acetate.

The ketone includes, for example, acetone, methyl ethyl ketone.

The ether includes, for example, diethyl ether, methyl tert-butyl ether, diisopropyl ether, dimethoxymethane, 1,3-dioxolan, 4-methyldioxolan, tetrahydrofuran, methyltetrahydrofuran, 1,4-dioxane.

The alcohol includes, for example, methanol, ethanol, 2-propanol.

The hydrocarbon includes, for example, n-pentane, cyclohexane, n-hexane, benzene, toluene.

The organic solvent to be used along with the essential solvent includes halogenohydrocarbons, esters, ketones, ethers, alcohols, and hydrocarbons. These may have a branched structure or a cyclic structure. The organic solvent may have two or more functional groups of ester, ketone, ether and alcohol (i.e., —O—, —CO—, —COO—, —OH). The hydrogen atom in the hydrocarbon moiety of the above ester, ketone, ether and alcohol may be substituted with a halogen atom (especially, fluorine atom).

The halogenohydrocarbon is preferably a chlorohydrocarbon, for example, including dichloromethane and chloroform. More preferred is dichloromethane.

The ester includes, for example, methyl formate, ethyl formate, propyl formate, pentyl formate, methyl acetate, ethyl acetate, pentyl acetate.

The ketone includes, for example, acetone, methyl ethyl ketone, diethyl ketone, diisobutyl ketone, cyclopentanone, cyclohexanone, methylcyclohexanone.

The ether includes, for example, diethyl ether, methyl tert-butyl ether, diisopropyl ether, dimethoxymethane, dimethoxyethane, 1,4-dioxane, 1,3-dioxolan, 4-methyldioxolan, tetrahydrofuran, methyltetrahydrofuran, anisole, phenetole.

The alcohol includes, for example, methanol, ethanol, 1-propanol, 2-propanol, 1-butanol, 2-butanol, tert-butanol, 1-pentanol, 2-methyl-2-butanol, cyclohexanol, 2-fluoroethanol, 2,2,2-trifluoroethanol, 2,2,3,3-tetrafluoro-1-propanol.

The hydrocarbon includes, for example, n-pentane, cyclohexane, n-hexane, benzene, toluene, xylene.

The solvent having at least two functional groups include, for example, 2-ethoxyethyl acetate, 2-methoxyethanol, 2-butoxyethanol, methyl acetacetate.

When the polymer that constitutes the transparent polymer film of the invention contains cellulose acylate, then the solvent preferably contains alcohol in an amount of from 5 to 30% by mass of the overall solvent, more preferably from 7 to 25% by mass, even more preferably from 10 to 20% by mass, from the viewpoint of reducing the peeling load from a band.

From the viewpoint of reducing Rth, it is desirable that the polymer solution to be used in producing the transparent polymer film of the invention contains an organic solvent which has a boiling point of at least 95° C. and has an evaporation profile of such that its proportion to evaporate along with halogenohydrocarbon in the initial stage of drying is small and then it is gradually concentrated and which is a bad solvent for cellulose ester, in an amount of from 1 to 15% by mass, more preferably from 1.5 to 13% by mass, even more preferably from 2 to 10% by mass.

Hereinunder described are preferred examples of a combination of organic solvents that are favorably used as a solvent for the polymer solution to be used in producing the transparent polymer film of the invention, to which, however, the solvent combination usable in the invention should not be limited. The numerical value for the ratio means part by mass.

(1) dichloromethane/methanol/ethanol/butanol=80/10/5/5
(2) dichloromethane/methanol/ethanol/butanol=80/5/5/10
(3) dichloromethane/isobutyl alcohol=90/10
(4) dichloromethane/acetone/methanol/propanol=80/5/5/10
(5) dichloromethane/methanol/butanol/cyclohexane=80/8/10/2
(6) dichloromethane/methyl ethyl ketone/methanol/butanol=80/10/5/5
(7) dichloromethane-butanol=90/10
(8) dichloromethane/acetone/methyl ethyl ketone/ethanol/butanol=68/10/10/7/5
(9) dichloromethane/cyclopentanone/methanol/pentanol=80/2/15/3
(10) dichloromethane/methyl acetate/ethanol/butanol=70/12/15/3
(11) dichloromethane/methyl ethyl ketone/methanol/butanol=80/5/5/10
(12) dichloromethane/methyl ethyl ketone/acetone/methanol/pentanol=50/20/15/5/10
(13) dichloromethane/1,3-dioxolan/methanol/butanol=70/15/5/10
(14) dichloromethane/dioxane/acetone/methanol/butanol=75/5/10/5/5
(15) dichloromethane/acetone/cyclopentanone/ethanol/isobutyl alcohol/cyclohexane=60/18/3/10/7/2
(16) dichloromethane/methyl ethyl ketone/acetone/isobutyl alcohol=70/10/10/10
(17) dichloromethane/acetone/ethyl acetate/butanol/hexane=69/10/10/10/1
(18) dichloromethane/methyl acetate/methanol/isobutyl alcohol=65/15/10/10
(19) dichloromethane/cyclopentanone/ethanol/butanol=85/7/3/5
(20) dichloromethane/methanol/butanol=83/15/2
(21) dichloromethane=100
(22) acetone/ethanol/butanol=80/15/5
(23) methyl acetate/acetone/methanol/butanol=75/10/10/5
(24) 1,3-dioxolan=100
(25) dichloromethane/methanol=85/15
(26) dichloromethane/methanol=92/8
(27) dichloromethane/methanol=90/10
(28) dichloromethane/methanol=87/13
(29) dichloromethane/ethanol=90/10

The details of a case where a non-halogen organic solvent is the essential solvent are described in Hatsumei Kyokai Disclosure Bulletin (No. 2001-1745, published by the Hatsumei Kyokai on Mar. 15, 2001), and they may be suitably referred to herein.

### (Solution Concentration)

The polymer concentration in the polymer solution to be prepared herein is preferably from 5 to 40% by mass, more preferably from 10 to 30% by mass, most preferably from 15 to 30% by mass.

The polymer concentration may be controlled in such a manner that it could have a predetermined concentration in the stage where polymer is dissolved in solvent. A low-concentration solution (e.g., from 4 to 14% by mass) may be previously prepared, and it may be concentrated by evaporation of the solvent. A high-concentration solution may be prepared, and it may be diluted. When additives are added thereto, the polymer concentration of the solution may also be lowered.

### (Additives)

The polymer solution to be used for producing the transparent polymer film of the invention may contain various liquid or solid additives added thereto in each preparation step, in accordance with the application of the film. Examples of the additives are plasticizer (its preferred amount is from 0.01 to 10% by weight of the polymer—the same shall apply hereinunder), UV absorbent (0.001 to 1% by mass), fine powder having a mean particle size of from 5 to 3000 nm (0.001 to 1% by mass), fluorine-containing surfactant (0.001 to 1% by mass), release agent (0.0001 to 1% by mass), antioxidant (0.0001 to 1% by mass), optical anisotropy controller (0.01 to 10% by mass), IR absorbent (0.001 to 1% by mass).

The plasticizer and the optical anisotropy controller are organic compounds having a molecular weight of at most 3000, preferably having both a hydrophobic moiety and a hydrophilic moiety. These compounds may change retardation through polymer chain alignment. In addition, when combined with cellulose acylate preferably used in the invention, these compounds may increase the hydrophobicity of the film and may reduce the humidity-dependent retardation change thereof. When the film contains the above-mentioned UV absorbent and IR absorbent, then the wavelength-dependent retardation of the film may be effectively controlled. Preferably, the additives to the transparent polymer film of the invention are all substantially free from evaporation during the step of drying the film.

From the viewpoint of reducing the humidity-dependent retardation change of the film, the amount of the additive to be added to the film is preferably larger. However, the increase in the amount of the additive in the film may often cause problems in that the glass transition temperature (Tg) of the polymer film may lower, and the additive may evaporate away during production of the film. Accordingly, when the polymer is cellulose acetate that is preferably used in the invention, then the amount of the additive having a molecular weight of at most 3000 is preferably from 0.01 to 30% by mass of the polymer, more preferably from 2 to 30% by mass, even more preferably from 5 to 20% by mass.

The plasticizer preferably used for cellulose acylate, which is preferred for the polymer to constitute the transparent polymer film of the invention, is described in JP-A-2001-151901. The UV absorbent is described in JP-A-2001-194522. The time when the additive is added to the polymer may be suitably determined depending on the type of the additive. The additive is also described in Hatsumei Kyokai Disclosure Bulletin (No. 2001-1745, published by the Hatsumei Kyokai on Mar. 15, 2001), pp. 16-22.

### (Preparation of Polymer Solution)

The polymer solution may be prepared, for example, according to the method described in JP-A-2005-104148, pp. 106-120. Concretely, a polymer and a solvent are mixed, stirred and swollen, and optionally cooled or heated to dissolve the polymer, and this is filtered to obtain the polymer solution.

### [Casting, Drying]

Using an ordinary solution-casting film formation apparatus, the transparent polymer film of the invention may be produced according to an ordinary solution-casting film formation method. Concretely, a dope (polymer solution) prepared in a dissolver (tank) is filtered, and then it is once stored in a storage tank in which the dope is defoamed to be a final dope. The dope is kept warmed at 30° C., and fed into a pressure die from the dope take-out port, for example, via a pressure meter gear pump via which a predetermined amount of the dope may be accurately fed to the die by controlling the revolution thereof, and then the dope is then uniformly cast onto a metal support in the casting zone that runs endlessly, through the slit of the pressure die (casting step). Next, at the peeling point at which the metal support runs almost one-round, a wet dope film (this may be referred to as a web) is peeled from the metal support, and then transported to a drying zone, in which the web is dried while transported therein by rolls. In the invention, a metal band or a metal drum may be used for the metal support.

The details of the casting step and the drying step are described also in JP-A-2005-104148, pp. 120-146, and these may be suitably applied to the invention.

The residual solvent amount in the thus-dried film is preferably from 0 to 2% by mass, more preferably from 0 to 1% by mass. After dried, the film may be transported to a heat-treatment zone, or after the film is once wound up, it may be subjected to off-line heat treatment. Preferably, the transparent polymer film before heat treatment has a width of from 0.5 to 5 m, more preferably from 0.7 to 3 m. In case where the film is once wound up, then, the preferred length of the wound film is from 300 to 30000 m, more preferably from 500 to 10000 m, even more preferably from 1000 to 7000 m.

### [Stretching]

In the invention, the transparent polymer film produced in the manner as above is stretched under a high temperature condition much exceeding Tg, for the purpose of attaining the intended modulus of elasticity.

### (Temperature)

The production method of the invention comprises stretching a transparent polymer film at (Tg+50)° C. or higher, more preferably at (Tg+60)° C. or higher, even more preferably at (Tg+65)° C. to (Tg+150)° C., still more preferably at (Tg+70)° C. to (Tg+100)° C. In case where the essential polymer ingredient of the polymer film is cellulose acylate, the temperature is 200° C. or higher, preferably from 210 to 270° C., more preferably from 220 to 250° C. Specifically defining the stretching temperature as above improves the motility of the polymer chains, therefore preventing the film from whitening (that is, preventing the haze of the film from increasing) owing to the increase in the draw ratio in film stretching and preventing the film from cutting. In addition, controlling the stretching speed and the draw ratio in stretching in the manner mentioned hereinunder makes it possible to suitably control the balance between the aggregation and the alignment of the polymer chains and the thermal relaxation thereof that occurs simultaneously with the former. Accordingly, the production method of the invention makes it possible to highly promote the aggregation and the alignment of the polymer chains in the film, and makes it possible to produce the transparent polymer film of the invention which has an extremely large modulus of elasticity and a suitable water vapor permeability and has little humidity-dependent dimensional change and which no one could heretofore reach.

### (Stretching Method)

The film may be stretched by holding its both edges with a chuck and expanding it in the direction vertical to the machine direction thereof (cross stretching). Preferably, however, the film is stretched in the machine direction. For example, the film is preferably stretched in the machine direction thereof in a device that has a heating zone between two or more nip rolls of which the peripheral speed of those on the take-out side is kept higher (zone stretching). The draw ratio in stretching may be suitably determined depending on the necessary modulus of elasticity of the stretched film. Preferably, it is from 10 to 500%, more preferably from 30 to 200%, even more preferably from 50 to 150%, still more preferably from 70 to 100%. The stretching may be effected in one stage or in multiple stages. The “draw ratio in stretching (%)” as referred to herein is defined as in the following formula. The pulling speed is preferably 20%/min, more preferably from 20 to 10000%/min, even more preferably from 50 to 5000%/min, still more preferably from 100 to 1000%/min, especially preferably from 150 to 800%/min.

Draw Ratio (%)=100×{(length after stretching)−(length before stretching)}/(length before stretching).

Preferably, the transparent polymer film of the invention has a single-layered structure. The “single-layered” film as referred to herein means a one-sheet polymer film but not a laminate film of plural films stuck together. This includes a case of producing a one-sheet polymer film from plural polymer solutions according to a successive casting system or a co-casting system. In this case, the type and the blend ratio of the additives to be used as well as the molecular weight distribution of the polymer to be sued and the type of the polymer may be suitably controlled to thereby produce a polymer film having a distribution in the thickness direction thereof. The one-sheet film may comprise various functional parts of an optically anisotropic part, an antiglare part, a gas-barrier part and a moisture-proof part.

### [Surface Treatment]

The transparent polymer film of the invention may be suitably surface-treated so as to improve its adhesion to various functional layers (e.g., undercoat layer, back layer, optically anisotropic layer). The surface treatment includes glow discharge treatment, UV irradiation treatment, corona treatment, flame treatment, saponification treatment (acid saponification, alkali saponification); and glow discharge treatment and alkali saponification treatment are preferred. The “glow discharge treatment” is a treatment of processing a film surface with plasma in the presence of a plasma-exciting vapor. The details of the surface treatment are described in Hatsumei Kyokai Disclosure Bulletin (No. 2001-1745, published by the Hatsumei Kyokai on Mar. 15, 2001), and may be suitably applied to the invention.

For improving the adhesiveness between the film surface and a functional layer thereon, an undercoat layer (adhesive layer) may be provided on the transparent polymer film, in addition to the surface treatment or in place of the surface treatment. The undercoat layer is described in Hatsumei Kyokai Disclosure Bulletin (No. 2001-1745, published by the Hatsumei Kyokai on Mar. 15, 2001), p. 32, which may be suitably applied to the invention. The functional layers that may be provided on the transparent polymer film of the invention are described in Hatsumei Kyokai Disclosure Bulletin (No. 2001-1745, published by the Hatsumei Kyokai on Mar. 15, 2001), pp. 32-45, and they may be suitably applied to the invention.

### <<Optical Compensatory Film>>

The transparent polymer film of the invention may be used as an optical compensatory film. “Optical compensatory film” is meant to indicate an optical material having optical anisotropy which is used generally in display devices such as liquid crystal display devices, and it has the same meaning as that of retardation film, retardation plate, optical compensatory sheet. In a liquid crystal display device, the optical compensatory film is used for the purpose of increasing the display panel contrast and of improving the viewing angle characteristics and the color of the device.

The transparent polymer film of the invention may be used as an optical compensatory film directly as it is. A plurality of the transparent polymer films of the invention may be laminated, or the transparent polymer film of the invention may be laminated with any other film falling outside the invention to thereby suitably control Re and Rth of the resulting laminate serving as an optical compensatory film. The films may be laminated with a sticky agent or adhesive.

As the case may be, the transparent polymer film of the invention may be used as a support of an optical compensatory film, and an optically anisotropic layer of liquid crystal or the like may be provided on it to construct an optical compensatory film. The optically anisotropic layer to be applied to the optical compensatory film of the invention may be formed of, for example, a liquid crystalline compound-containing composition or a birefringent polymer film.

The liquid crystalline compound is preferably a discotic liquid crystalline compound or a rod-shaped liquid crystalline compound.

### [Discotic Liquid Crystalline Compound]

Examples of discotic liquid crystalline compounds usable in the invention are described in various documents (e.g., C. Destrade et al., Mol. Cryst. Liq. Cryst., Vol. 71, p. 111 (1981); Quarterly Journal of General Chemistry, edited by the Chemical Society of Japan, No. 22, Chemistry of Liquid Crystal, Chap. 5, Chap. 10, Sec. 2 (1994); B. Kohne et al., Angew. Chem. Soc. Chem. Comm., p. 1794 (1985): J. Zhang et al., J. Am. Chem. Soc., Vol. 116, p. 2655 (1994)).

In the optically anisotropic layer, the discotic liquid crystalline molecules are preferably fixed as aligned. Most preferably, the molecules are fixed through polymerization. Polymerization of discotic liquid crystalline molecules is described in JP-A-8-27284. For fixing the discotic liquid crystalline molecules through polymerization, the discotic core of the discotic liquid crystalline molecules must be substituted with a polymerizing group. However, when a polymerizing group is bonded directly to the discotic core, then the molecules could hardly keep their alignment state during polymerization. Accordingly, a linking group is introduced between the discotic core and the polymerizing group. Polymerizing group-having discotic liquid crystalline molecules are described in JP-A-2001-4387.

### [Rod-Shaped Liquid Crystalline Compound]

Examples of rod-shaped liquid crystalline compounds usable in the invention are azomethines, azoxy compounds, cyanobiphenyls, cyanophenyl esters, benzoates, phenyl cyclohexanecarboxylates, cyanophenylcyclohexanes, cyano-substituted phenylpyrimidines, alkoxy-substituted phenylpyrimidines, phenyldioxanes, tolanes and alkenylcyclohexylbenzonitriles. The rod-shaped liquid crystalline compound for use herein is not limited to these low-molecular liquid crystalline compounds but includes polymer liquid crystalline compounds.

In the optically anisotropic layer, the rod-shaped liquid crystalline molecules are preferably fixed as aligned. Most preferably, the molecules are fixed through polymerization. Examples of the polymerizing rod-shaped liquid crystalline compound usable in the invention are described, for example, in Makromol. Chem., Vol. 190, p. 2255 (1989); Advanced Materials, Vol. 5, p. 107 (1993); U.S. Pat. Nos. 4,683,327, 5,622,648, 5,770,107, WO95/22586, WO95/24455, WO97/00600, WO98/23580, WO98/52905, JP-A-1-272551, JP-A-6-16616, JP-A-7-110469, JP-A-11-800B1, JP-A-2001-328973.

### (Optically Anisotropic Layer of Polymer Film)

The optically anisotropic layer may also be formed of a polymer film. The polymer film may be formed of a polymer capable of expressing optical anisotropy. Examples of the polymer capable of expressing optical anisotropy include polyolefins (e.g., polyethylene, polypropylene, norbornene-based polymer), polycarbonates, polyarylates, polysulfones, polyvinyl alcohols, polymethacrylates, polyacrylates, and cellulose esters (e.g., cellulose triacetate, cellulose diacetate). The polymer may also be a copolymer of those polymers or a mixture thereof.

### <<Laminate Film>>

The transparent polymer film or the optical compensatory film of the invention may be laminated with the transparent polymer film or the optical compensatory film of the invention stuck thereto. The transparent polymer film or the optical compensatory film of the invention may be laminated with a transparent polymer film or an optical compensatory film falling outside the invention, stuck thereto. The films may be laminated with a sticky agent or adhesive.

The lamination of the films may be effected in on-line or off-line operation. Preferably, it is effected in on-line operation from the viewpoint of producibility. In this case, when the angle between the direction in which the modulus of elasticity of the transparent polymer film of the invention is the largest and the direction in which the modulus of elasticity of the transparent polymer film falling outside the invention is the largest is smaller, then it is desirable since the environment-dependent dimensional change of the transparent polymer film falling outside the invention may be retarded; and the angle between the direction in which the modulus of elasticity of the transparent polymer film of the invention is the largest and the direction in which the modulus of elasticity of the transparent polymer film falling outside the invention is the largest is preferably at most 15°, more preferably at most 10°, even more preferably at most 5°, most preferably at most 2°.

The essential polymer ingredient of the transparent polymer film falling outside the invention includes cellulose ester, polyester, polycarbonate, cyclo-olefin polymer, vinyl polymer, polyamide, polyimide, and amylose. Of those, preferred are polyester and vinyl polymer; more preferred are polyethylene terephthalate and polyvinyl alcohol; and even more preferred are polyvinyl alcohol obtained through hydrolysis of polyvinyl acetate.

Not specifically defined, the whole light transmittance of the laminate film of the invention is preferably at most 50%, more preferably from 30 to 50%, even more preferably from 40 to 49%.

Preferably, dichroic molecules are introduced into the transparent polymer film falling outside the invention. The dichroic molecule is preferably a high-order iodide ion such as I³⁻ or I⁵⁻, or a dichroic dye. In addition, the dichroic molecules-containing film is preferably stretched, more preferably a polarizing film having a function of polarization and separation.

### <<Polarizer>>

The transparent polymer film, the optical compensatory film and the laminate film of the invention may be sued as a protective film of a polarizer (the polarizer of the invention). The polarizer of the invention comprises a polarizing film and two polarizer-protective films (transparent polymer films) for protecting both surfaces of the polarizing film, in which the transparent polymer film or the retardation film of the invention may be used as at least one polarizer-protective film. The transparent polymer film, the optical compensatory film or the laminate film of the invention may be stuck to a polarizing film with an adhesive in a roll-to-roll line mode.

In case where the transparent polymer film of the invention is used as the above-mentioned, polarizer-protective film, it is desirable that the transparent polymer film of the invention is subjected to the above-mentioned surface treatment (as in JP-A-6-94915, JP-A-6-118232) for hydrophilicating its surface. For example, the film is preferably processed by glow discharge treatment, corona discharge treatment of alkali saponification. In particular, when the polymer that constituted the transparent polymer film of the invention is cellulose acylate, then alkali saponification is the most preferred for the surface treatment.

The polarizing film for use herein may be prepared by dipping a polyvinyl alcohol film in an iodine solution and stretching it. In case where such a polarizing film prepared by dipping a polyvinyl alcohol film in an iodine solution and stretching it is used, the transparent polymer film of the invention may be directly stuck to both surfaces of the polarizing film with an adhesive, with its surface-treated face being inside of the resulting structure. In the invention, it is desirable that the transparent polymer film is directly stuck to a polarizing film in that manner. The adhesive may be an aqueous solution of polyvinyl alcohol or polyvinyl acetal (e.g., polyvinyl butyral), or a latex of a vinylic polymer (e.g., polybutyl acrylate). An aqueous solution of a completely-saponified polyvinyl alcohol is especially preferred for the adhesive.

In a liquid crystal display device, in general, a liquid crystal cell is provided between two polarizers. The device therefore has four polarizer-protective films. The transparent polymer film of the invention may be favorably applied to any of those four polarizer-protective films. In case where the transparent polymer film of the invention is used as an outer protective film in a liquid crystal display device, not disposed between the polarizing film and the liquid crystal layer (liquid crystal cell) therein, then a transparent hard-coat layer, an antiglare layer and an antireflection layer may be provided on the film. In particular, the film is favorably used as a polarizer-protective film of the outermost surface on the display side of a liquid crystal display device.

### <<Liquid Crystal Display Device>>

The transparent polymer film, the optical compensatory film, the laminate film and the polarizer of the invention may be used in liquid crystal display devices of various display modes. The transparent polymer film, the optical compensatory film and the laminate film of the invention have a high modulus of elasticity and have a small humidity-dependent expansion coefficient, and therefore, in the polarizer comprising it, the film of the invention prevents the dimensional change by heat and moisture of the polarizing element therein. Accordingly, the film may prevent light leakage that may occur in the peripheral area of a display panel owing to heat or moisture environment change applied thereto.

Various liquid crystal modes in which the film is used are described below. The liquid crystal display devices may be any of transmission-type, reflection-type or semitransmission-type ones.

### (TN-Mode Liquid Crystal Display Device)

The transparent polymer film of the invention may be used as a support of an optical compensatory film in a TN-mode liquid crystal display device having a TN-mode liquid crystal cell. TN-mode liquid crystal cells and TN-mode liquid crystal display devices are well known from the past. The optical compensatory film for use in TN-mode liquid crystal display devices is described in JP-A-3-9325, JP-A-6-148429, JP-A-8-50206, JP-A-9-26572; and in Mori et al's reports (Jpn. J. Appl. Phys., Vol. 36 (1997), p. 143; Jpn. J. Appl. Phys., Vol. 36 (1997), p. 1068).

### (STN-Mode Liquid Crystal Display Device)

The transparent polymer film of the invention may be used as a support of an optical compensatory film in an STN-mode liquid crystal display device having an STN-mode liquid crystal cell. In an STN-mode liquid crystal display device, in general, the rod-shaped liquid crystalline molecules in the liquid crystal cell are twisted within a range of from 90 to 360 degrees, and the product (Δnd) of the refractivity anisotropy (Δn) of the rod-shaped liquid crystalline molecules and the cell gap (d) falls within a range of from 300 to 1500 nm. Optical compensatory films for use in STN-mode liquid crystal display devices are described in JP-A-2000-105316

### (VA-Mode Liquid Crystal Display Device)

The transparent polymer film of the invention may be used as an optical compensatory film or as a support of an optical compensatory film in a VA-mode liquid crystal display device having a VA-mode liquid crystal cell. The VA-mode liquid crystal display device may be a domain-division system device as described in JP-A-10-123576, for example.

### (IPS-Mode Liquid Crystal Display Device and ECB-Mode Liquid Crystal Display Device)

The transparent polymer film of the invention is especially advantageously used as an optical compensatory film, as a support of an optical compensatory film or as a protective film of a polarizer in an IPS-mode liquid crystal display device and an ECB-mode liquid crystal display device having an IPS-mode or ECB-mode liquid crystal cell. In these modes, the liquid crystal display material is aligned nearly in parallel to each other at the time of black level of display, and under a condition of no voltage application thereto, the liquid crystal molecules are aligned in parallel to the substrate face to give black display.

### (OCB-Mode Liquid Crystal Display Device and HAN-Mode Liquid Crystal Display Device)

The transparent polymer film of the invention is advantageously used as a support of an optical compensatory film in an OCB-mode liquid crystal cell-having OCB-mode liquid crystal display device or a HAN-mode liquid crystal cell-having HAN-mode liquid crystal display device. It is desirable that, in an optical compensatory film in an OCB-mode liquid crystal display device and a HAN-mode liquid crystal display device, the direction in which the absolute value of the retardation of the film is the smallest is not the in-plane direction or the normal direction of the optical compensatory film. The optical properties of the optical compensatory film for use in an OCB-mode liquid crystal display device or a HAN-mode liquid crystal display device depend on the optical properties of the optically anisotropic layer, the optical properties of the support and the configuration of the optically anisotropic layer and the support of the film. Optical compensatory films for use in an OCB-mode liquid crystal display device and a HAN-mode liquid crystal display device are described in JP-A-9-197397. In addition, they are also described in Mori et al's report (Jpn. J. Appl. Phys., Vol. 38 (1999), p. 2837).

### (Reflection-Type Liquid Crystal Display Device)

The transparent polymer film of the invention may be advantageously used as an optical compensatory film of TN-mode, STN-mode, HAN-mode or GH (guest-host)-mode reflection-type liquid crystal display devices. These display modes are well known from the past. TN-mode reflection-type liquid crystal display devices are described in JP-A-10-123478, WO98/48320, Japanese Patent 3022477. Optical compensatory films for use in reflection-type liquid crystal display devices are described in WO00/65384.

### (Other Liquid Crystal Display Devices)

The transparent polymer film of the invention may be advantageously used as a support of an optical compensatory film in an ASM (axially symmetric aligned microcell)-mode liquid crystal cell-having ASM-mode liquid crystal display device. The ASM-mode liquid crystal cell is characterized in that the cell thickness is held by a position-controllable resin spacer. The other properties of the cell are the same as those of the TN-mode liquid crystal cell. ASM-mode liquid crystal cells and ASM-mode liquid crystal display devices are described in Kume et al's report (Kume et al., SID 98 Digest 1089 (1998)).

### [Other Applications]

### (Hard Coat Film, Antiglare Film, Antireflection Film)

As the case may be, the transparent polymer film of the invention may be applied to a hard coat film, an antiglare film and an antireflection film. For the purpose of improving the visibility of LCD, PDP, CRT or EL flat panel displays, any or all of a hard coat layer, an antiglare layer and an antireflection layer may be give to one face or both faces of the transparent polymer film of the invention. Preferred embodiments of such antiglare films and antireflection films are described in detail in Hatsumei Kyokai Disclosure Bulletin (No. 2001-1745, published by the Hatsumei Kyokai on Mar. 15, 2001), pp. 54-57, and these are also preferred for the transparent polymer film of the invention.

### EXAMPLES

The invention is described in more detail with reference to the following Examples and Comparative Examples. In the following Examples, the material used, its amount and the ratio, the details of the treatment and the treatment process may be suitably modified or changed not overstepping the sprit and the scope of the invention. Accordingly, the invention should not be limitatively interpreted by the Examples mentioned below.

### <<Measurement Methods>>

Measurement methods and evaluation methods for the properties used in the following Examples and Comparative Examples are shown below.

### [Modulus of Elasticity]

The film to be tested is sampled at three points in the cross direction thereof (center, and both edges (at the position of 5% of the overall width from both edges)) at intervals of 100 m in the machine direction, and these are tested according to the method mentioned above. The data of every point are averaged, and the resulting mean value indicates the modulus of elasticity. Unless otherwise specifically indicated, the film is so sampled that the traveling direction could be the machine direction.

### [Elastic Modulus Change]

According to the above-mentioned method, the elastic modulus change of the stretched film is determined.

### [Moisture-Dependent Expansion Coefficient]

The film to be tested is sampled at three points in the cross direction thereof (center, and both edges (at the position of 5% of the overall width from both edges)) at intervals of 100 m in the machine direction, and these are tested according to the method mentioned above. The data of every point are averaged, and the resulting mean value indicates the moisture-dependent expansion coefficient of the film

### [Whole Light Transmittance]

The film to be tested is sampled at five points in the cross direction thereof (center, and both edges (at the position of 5% of the overall width from both edges), and two intermediates between the center and the edge) at intervals of 100 m in the machine direction, and these are tested according to the method mentioned above. The data of every point are averaged, and the resulting mean value indicates the whole light transmittance of the film.

### [Haze]

The film to be tested is sampled at five points in the cross direction thereof (center, and both edges (at the position of 5% of the overall width from both edges), and two intermediates between the center and the edge) at intervals of 100 m in the machine direction, and these are tested according to the method mentioned above. The data of every point are averaged, and the resulting mean value indicates the haze of the film.

### [Water Vapor Permeability]

The film is tested according to the above-mentioned method, and the resulting value indicates the water vapor permeability of the film as calculated in terms of the film having a thickness of 80 μm.

### [Tg]

The film is tested according to the above-mentioned method to determine its Tg.

### [Surface Condition]

The surface of the transparent polymer film is visually checked, and the surface condition of the film is evaluated according to the criteria mentioned below.

Good: Its surface condition is good, and the film is favorable for optical use.
Not Good: The film surface entirely whitened, and the film is unfavorable for practical use.

### [Retardation]

The film to be tested is sampled at five points in the cross direction thereof (center, and both edges (at the position of 5% of the overall width from both edges), and two intermediates between the center and the edge) at intervals of 100 m in the machine direction, thereby giving samples having a size of 2 cm×2 cm. These samples are tested according to the method mentioned below. The data of every point are averaged to be Re and Rth. Concretely, the film sample is first conditioned at 25° C. and 60% RH for 24 hours. Then, using a prism coupler (Model 2010 Prism Coupler, by Metricon) at 25° C. and 60% RH, the mean refractive index (n) of each sample, as represented by the following formula (a), is determined with a 632.8-nm He—Ne laser.

n=(n_{TE}×2+n_{TM})/3 (a)

wherein n_{TE} is the refractive index measured with polarized light in the direction of the film face; n_{TM} is the refractive index measured with polarizing light in the normal direction to the film face.

Next, using a birefringence meter (ABR-10A, by Uniopt) at 25° C. and 60% RH, the retardation of the conditioned film is measured with a 632.8-nm He—Ne laser, in the vertical direction to the film surface and in the direction inclined by ±40° from the normal line to the film face relative to the in-plane slow axis as the inclination axis (rotation axis). From the data as combined with the mean refractive index measured in the above, nx, ny and nz are computed, and the in-plane retardation (Re) and the thickness-direction retardation (Rth), as represented by the following formulae (b) and (c), respectively, are computed.

Re(nx−ny)×d (b)

Rth={(nx+ny)/2−nz}×d (c)

wherein nx is the in-plane refractive index in the slow axis (x) direction; ny is the in-plane refractive index in the direction vertical to the x direction; nz is the refractive index in the thickness direction of the film (in the normal direction to the film face); d is the film thickness (nm). The slow axis is in the direction in which the in-plane refractive index is the largest.

### [Degree of Polarization]

The produced two polarizers are stacked up with their absorption axes kept in parallel to each other, and the transmittance (Tp) is measured. They are stacked up with their absorption axes kept vertical to each other, and the transmittance (Tc) is measured. The degree of polarization (P), as represented by the following formula, is computed.

Degree of Polarization P=((Tp−Tc)/(Tp+Tc))^{0.5}

### Examples 101 to 114, Comparative Examples 101 to 106

### Film Formation

In Examples and Comparative Examples, the following films were used (see Table 1).

Film A: A film was prepared according to Example 1 in JP-A-2005-104148, and this is film A.
Film B: A commercially-available film, Fujitac (T80UZ, by Fuji Photo Film) was used as it was.
Film C: A film was prepared according to Example 12 in JP-A-2005-104148, and this is film C.
Film D: A commercially-available film, Fujitac (TD80UL, by Fuji Photo Film) was used as it was.
Film E: A commercially-available film (by Kuraray, having a thickness of 75 μm, and a water vapor permeability at 40° C. and 90% RH, in terms of the film having a thickness of 80 μm, of 3300 g/(m²·day)) was used as it was (Comparative Example 105).
Film F: A commercially-available Zeonor film (by Nippon Zeon, having a thickness of 100 μm, and a water vapor permeability at 40° C. and 90% RH, in terms of the film having a thickness of 80 μm, of 0 g/(m²·day)) was used as it was (Comparative Example 106).

### (Stretching)

In Examples and Comparative Examples, the films were stretched according to the following stretching step (see Table 1).

### Stretching A:

The transparent polymer films A to D were monoaxially stretched in the machine direction under the condition shown in Table 1, using a roll stretcher. The roll stretcher comprises two nip rolls, in which each roll was a mirror-finished induction-heating jacket roll. The temperature of each roll could be controlled individually. The stretching zone was covered with a casing to have the temperature as in Table 1. The roll before the stretching zone was so controlled that it cold be gradually heated at the stretching temperature as in Table 1. The stretching distance was so controlled that the aspect ratio could be 3.3, and the film was stretched at the pulling rate as in Table 1. After stretched, the film was cooled and wound up. The draw ratio in stretching is given in Table 1.

### Stretching B:

The transparent film was stretched in a device having a heating zone of which the temperature was controlled as in Table 1, between two nip rolls. The draw ratio in stretching was controlled by controlling the peripheral speed of the nip rolls so that aspect ratio (distance between nip rolls/base width) could be 3.3. After stretched, the film was cooled and wound up. The draw ratio in stretching is given in Table 1.

### (Evaluation of Transparent Polymer Film)

The obtained, transparent polymer films were evaluated. The results are given in Table 1.

The water vapor permeability, in terms of the film having a thickness of 80 μm, of the films of Examples 101 to 114 and Comparative Examples 101 to 104 was all within a range of from 300 to 1000 g/(m²·day). In all Examples, the angle between the direction in which the modulus of elasticity of the film was the largest and the film traveling direction was at most 3°.

TABLE 1

| | | | | | | | | Mean Value |
|---|---|---|---|---|---|---|---|---|
| | | | Stretching | | | | Film | of Elastic |
| | Type of | Tg | | Temp. | Draw Ratio | Speed | Surface | Modulus |
| | Film | [° C.] | Step | [° C.] | [%] | [%/min] | Condition | [GPa] |
| Example 101 | Film A | 145 | stretching A | 200 | 60 | 100 | good | 7.5 |
| Comparative | Film B | 147 | stretching A | 180 | 60 | 100 | not good | 6.8 |
| Example 101 | | | | | | | | |
| Example 102 | Film B | 147 | stretching A | 200 | 60 | 100 | good | 7.5 |
| Example 103 | Film B | 147 | stretching A | 220 | 60 | 100 | good | 7.3 |
| Comparative | Film B | 147 | stretching A | 200 | 0 | — | good | 4.2 |
| Example 102 | | | | | | | | |
| Example 104 | Film B | 147 | stretching A | 200 | 20 | 100 | good | 5.2 |
| Example 105 | Film B | 147 | stretching A | 200 | 40 | 100 | good | 6.2 |
| Example 106 | Film B | 147 | stretching A | 200 | 80 | 100 | good | 8.0 |
| Example 107 | Film B | 147 | stretching A | 200 | 60 | 300 | good | 7.4 |
| Comparative | Film B | 147 | (not processed) | | | | good | 3.9 |
| Example 103 | | | | | | | | |
| Example 108 | Film C | 140 | stretching A | 200 | 20 | 300 | good | 6.0 |
| Example 109 | Film D | 140 | stretching A | 200 | 20 | 300 | good | 6.1 |
| Comparative | Film D | 140 | (not processed) | | | | good | 4.8 |
| Example 104 | | | | | | | | |
| Example 110 | Film B | 147 | stretching B | 220 | 80 | 100 | good | 7.1 |
| Example 111 | Film D | 140 | stretching B | 220 | 50 | 100 | good | 9.5 |
| Example 112 | Film B | 147 | stretching B | 200 | 20 | 50 | good | 5.0 |
| Example 113 | Film D | 140 | stretching A | 240 | 50 | 100 | good | 8.0 |
| Example 114 | Film B | 147 | stretching A | 240 | 15 | 10 | good | 4.9 |

| | | Mean Value | | | | |
|---|---|---|---|---|---|---|
| | Mean Value | of Humidity- | | | | |
| | of Elastic | Dependent | Mean Value | Mean | Mean | Mean |
| | Modulus | Expansion | of Whole Light | Value | Value | Value |
| | change | Coefficient | Transmittance | of Haze | of Re | of Rth |
| | [times] | [×10⁵/% RH] | [%] | [%] | [nm] | [nm] |
| Example 101 | 1.9 | 2.0 | 94.0 | 0.3 | 40 | −17 |
| Comparative | 1.7 | 2.3 | 92.6 | 25 | — | — |
| Example 101 | | | | | | |
| Example 102 | 1.9 | 1.9 | 94.0 | 0.3 | 41 | −17 |
| Example 103 | 1.9 | 2.8 | 94.1 | 0.3 | 80 | −40 |
| Comparative | 1.1 | 6.1 | 94.0 | 0.3 | 35 | −17 |
| Example 102 | | | | | | |
| Example 104 | 1.3 | 3.5 | 93.9 | 0.3 | 37 | −16 |
| Example 105 | 1.6 | 2.7 | 94.0 | 0.4 | 38 | −17 |
| Example 106 | 2.1 | 1.4 | 94.0 | 0.4 | 42 | −17 |
| Example 107 | 1.9 | 2.0 | 94.0 | 0.4 | 39 | −16 |
| Comparative | 1.0 | 6.1 | 93.8 | 0.3 | 1 | 47 |
| Example 103 | | | | | | |
| Example 108 | 1.3 | 2.3 | 92.5 | 0.2 | 80 | 25 |
| Example 109 | 1.3 | 2.3 | 92.4 | 0.2 | 79 | 26 |
| Comparative | 1.0 | 3.5 | 92.3 | 0.2 | 3 | 41 |
| Example 104 | | | | | | |
| Example 110 | 1.8 | 2.4 | 93.0 | 0.4 | 121 | −55 |
| Example 111 | 2.0 | 0.5 | 92.8 | 0.3 | 174 | 41 |
| Example 112 | 1.3 | 3.8 | 94.0 | 0.3 | 33 | −15 |
| Example 113 | 1.7 | 1.2 | 92.8 | 0.3 | 201 | 11 |
| Example 114 | 1.3 | 5.9 | 93.4 | 0.3 | 157 | −68 |

As in Table 1, films having a high modulus of elasticity and having little humidity-dependent dimensional change can be produced according to the method of the invention.

### Examples 201 to 214, Comparative Examples 202 to 205

### Formation of Polarizer

The obtained films were saponified in the manner mentioned below to produce polarizers. The polarizers produced from the films of Examples 101 to 114 are Examples 201 to 214; the polarizers produced from the films of Comparative Examples 102 to 104 are Comparative Examples 202 to 204; and the polarizer produced from the film E is Comparative Examples 205. The whole light transmittances of these polarizers were from 40 to 45%.

### 1) Saponification of Film:

The film was conditioned at 55° C., and dipped in an aqueous NaOH (1.5 mol/L) solution (saponification solution) for 2 minutes, then washed with water, and then dipped in an aqueous sulfuric acid (0.05 mol/L) solution for 30 seconds, and thereafter led to pass through a water bath. Then, this was dewatered repeatedly three times with an air knife to remove water, and then kept in a drying zone at 70° C. for 15 seconds to be dried. The process gave a saponified film.

### 2) Formation of Polarizing Film:

According to Example 1 in JP-A-2001-141926, the film was stretched in the machine direction between two pairs of nip rolls running at a different peripheral speed, thereby preparing a polarizing film having a thickness of 20 μm.

### 3) Lamination:

The obtained polarizing film was sandwiched between the above-mentioned two saponified films in such a manner that the machine direction of the saponified film could be in parallel to the machine direction of the polarizing film, via an adhesive of an aqueous 3% PVA (Kuraray's PVA-117H) solution put therebetween, and laminated in on-line operation. The film F could not give a polarizer owing to the adhesion failure thereof to the polarizing film.

### Comparative Example 207

A polarizer was produced in the same manner as in Comparative Example 201, for which, however, the lamination step 3) with the film of Example 101 in the process of polarizer production was changed to the following. This is Comparative Example 207.

### 3) Lamination:

The saponified cut film of Example 101 was laminated on both surfaces of the obtained polarizing film, using an adhesive of an aqueous 3% PVA (Kuraray's PVA-117H) solution put therebetween, in such a manner that the direction in which the modulus of elasticity of the film is the largest could be perpendicular to the machine direction of the polarizing film.

### (Evaluation of Polarizer)

### [Initial Degree of Polarization]

The degree of polarization of the polarizer was determined according to the above-mentioned method. All the polarizers of Examples 201 to 214 and Comparative Examples 202 to 205 and Comparative Example 207 had a degree of polarization of at least 99.9%. However, when the film of Comparative Example 106 was used, a polarizer could not be produced owing to the adhesion failure between the film and the polarizing film.

[Degree of Polarization 1 after Aging]

The polarizer was stuck to a glass plate with an adhesive, and left at 60° C. and 95% RH for 500 hours. After thus left, the degree of polarization (after aging) of the polarizer was computed according to the above-mentioned method. All the polarizers of Examples 201 to 214 and Comparative Examples 202 to 204 and Comparative Example 207 still had a degree of polarization of at least 99.9%. However, the degree of polarization of the polarizer of Comparative Example 205 lowered to less than 10%.

[Degree of Polarization 2 after Aging]

The polarizer was stuck to a glass plate with an adhesive, and left at 90° C. and 0% RH for 500 hours. After thus left, the degree of polarization (after aging) of the polarizer was computed according to the above-mentioned method. All the polarizers of Examples 201 to 214 and Comparative Examples 202 to 204 and Comparative Example 207 still had a degree of polarization of at least 99.9%. However, the degree of polarization of the polarizer of Comparative Example 205 lowered to less than 90%, and therefore the polarizer is unsuitable to display devices.

### (Evaluation in Mounting on TN-Mode Liquid Crystal Display Device)

The polarizer was built in a TN-mode liquid crystal display device (AQUOS LC20C1S, by Sharp) in place of its original polarizer, and kept at 60° C. and 0% RH for 1 day. Then, after 1 hour, the device was visually checked. When the polarizer of any of Examples 201 to 213 was built in the device, then no frame-like light leakage was found at four edges of the display panel, as compared with the other part of the panel; but when the polarizer of any of Comparative Examples 202 to 203 was built in, then some frame-like light leakage was found at four edges of the display panel, as compared with the other part of the panel. When the polarizer of Comparative Example 204 was built in the device, some frame-like light leakage was found. When the polarizer of Example 214 was built in the device, some slight frame-like light leakage was found in a dark room but with no problem in practical use. When the polarizer of Comparative Example 207 was built in the device, then serious frame-like light leakage was found. When the polarizer of Comparative Example 202 was built in the device, using an adhesive described in Example 1 in JP-A-2000-109771, the frame-like light leakage was reduced, but the light leakage was still confirmed in visual observation. As opposed to it, when the polarizer of the invention was built in the device, using the adhesive described in Example 1 in JP-A-2000-109771, then no frame-like light leakage was found.

### (Evaluation in Mounting on VA-Mode Liquid Crystal Display Device)

The polarizer was built in a VA-mode liquid crystal display device (32 V-mode high-definition liquid crystal TV monitor, W32-L7000, by Hitachi), and left at 60° C. and 95% RH for 1 week, and then at 25° C. and 60% RH for 1 day. With that, the device was visually checked. When the polarizer of Examples 201 to 213 was built in the device, then no frame-like light leakage was found at four edges of the display panel, as compared with the other part of the panel; but when the polarizer of Comparative Examples 202 to 203 was built in, then some frame-like light leakage was found at four edges of the display panel, as compared with the other part of the panel. When the polarizer of Comparative Example 204 was built in, then some light leakage was found at four edges. When the polarizer of Example 214 was built in, then some slight light leakage was found at four edges in a dark room but with no problem in practical use. When the polarizer of Comparative Example 207 was built in, severe light leakage was found at four edges.

### INDUSTRIAL APPLICABILITY

The invention provides a transparent polymer film having a high modulus of elasticity and a suitable water vapor permeability and having little humidity-dependent dimensional change. The invention also provides an optical compensatory film and a laminate film. Since the transparent polymer film of the invention has a suitable water vapor permeability, it can be stuck to a polarizing film in on-line operation, therefore providing good polarizers at high producibility. Further, the invention also provides a liquid crystal display device of high reliability, which is free from a trouble of light leakage that may occur in the peripheral area of the screen panel thereof owing to the environmental heat or moisture change. Accordingly, the industrial applicability of the invention is good.

1. A method for producing a transparent polymer film, which comprises stretching a starting transparent polymer film by at least 10% at (Tg+50)° C. or higher wherein the starting transparent polymer film has a water vapor permeability at 40° C. and 90% RH of at least 100 g/(m²·day) in terms of the film having a thickness of 80 μm, and Tg is a glass transition temperature of the starting transparent polymer film.

2. The method for producing a transparent polymer film according to claim 1, wherein the stretching is effected at (Tg+60)° C. or higher.

3. The method for producing a transparent polymer film according to claim 1, wherein the stretching is effected at 200° C. or higher.

4. The method for producing a transparent polymer film according to claim 1, wherein the modulus of elasticity of the starting transparent polymer film increases, after stretched, by from 1.1 to 100 times that of the unstretched film.

5. The method for producing a transparent polymer film according to claim 1, wherein the stretching is effected at a stretching rate of at least 20%/min.

6. The method for producing a transparent polymer film according to claim 1, wherein the stretching is machine-direction stretching to be effected in a device that has a heating zone between at least two nip rolls having a different peripheral speed.

7. A transparent polymer film produced according to the production method of claim 1.

8. A transparent polymer film having a modulus of elasticity of at least 5 GPa and having a water vapor permeability at 40° C. and 90% RH of from 100 to 2000 g/(m²·day) in terms of the film having a thickness of 80 μm.

9. The transparent polymer film according to claim 7, which has a humidity-dependent expansion coefficient of at most 6×10⁻⁵% RH.

10. The transparent polymer film according to claim 7, which has a whole light transmittance of at least 90%.

11. The transparent polymer film according to claim 7, which has a haze of at most 2%.

12. The transparent polymer film according to claim 7, which contains a cellulose ester as the essential polymer ingredient thereof.

13. The transparent polymer film according to claim 12, wherein the cellulose ester is a cellulose acetate.

14. An optical compensatory film having at least one transparent polymer film of claim 7.

15. A laminate film having at least one transparent polymer film of claim 7.

16. A laminate film comprising at least one transparent polymer film of claim 7, and any other polymer film stuck thereto.

17. The laminate film according to claim 16, wherein the angle between the direction in which the modulus of elasticity of the transparent polymer film is the largest and the direction in which the modulus of elasticity of the other transparent polymer film is the largest is at most 15°.

18. The laminate film according to claim 16, wherein the essential polymer ingredient of the other transparent polymer film is a polyvinyl alcohol.

19. The laminate film of according to claim 16, wherein the other transparent polymer film is a polarizing film.

20. The laminate film according to claim 15, which has a whole light transmittance of at most 50%.

21. A liquid crystal display device having at least one transparent polymer film of claim 7.
